(19) United States
(12) Patent Application Publication
(10) Pub. No.: US 2024/0365183 A1
(43) Pub. Date: Oct. 31, 2024

(54) METHODS, DEVICES, AND COMPUTER READABLE MEDIUM FOR COMMUNICATION

(71) Applicant: NEC CORPORATION, Tokyo (JP)

(72) Inventors: Zhe CHEN, Beijing (CN); Gang WANG, Beijing (CN)

(73) Assignee: NEC CORPORATION, Tokyo (JP)

(21) Appl. No.: 18/687,640

(22) PCT Filed: Aug. 31, 2021
(86) PCT No.: PCT/CN2021/115658

§ 371 Date: Feb. 28, 2024

(51) Int. Cl. H04W 36/00

(52) U.S. Cl. CPC H04W 36/0069

(57) ABSTRACT

According to embodiments of the present disclosure, a first device transmits configuration information associated with an Integrated Access Backhaul (IAB) node to a second device. The second device serves as a SN of the IAB node and the IAB node is moving. The configuration information comprises at least one of: a radio link control (RLC) channel of the IAB node, a RLC channel mapping rule of the IAB node or a routing table of the IAB node. In this way, the service interruption can be minimized and mobility robustness is enhanced.

### TECHNICAL FIELD

Embodiments of the present disclosure generally relate to the field of telecommunication, and in particular, to methods, devices, and computer readable medium for communication.

### BACKGROUND

In communication networks, a base station generally has a limited reach, to achieve connectivity between mobile devices. A technology of handover has been proposed, which is a process in telecommunication and mobile communication in which cellular transmission is transferred from one base station to another base station without losing connectivity to the cellular transmission. Moreover, if a communication device is moving in a high speed, the conventional handover of this communication device may not be applicable.

### SUMMARY

In general, example embodiments of the present disclosure provide a solution for communication.

In a first aspect, there is provided a communication method. The method comprises: transmitting, at a first device and to a second device which serves as a secondary node (SN) of a moving integrated access backhaul (IAB) node, configuration information associated with the moving IAB node, wherein the configuration information comprises at least one of: a radio link control (RLC) channel of the moving IAB node, a RLC channel mapping rule of the moving IAB node, or a routing table of the moving IAB node.

In a second aspect, there is provided a communication method. The method comprises: receiving, at a second device which serves as a secondary node (SN) of a moving integrated access backhaul (IAB) node and from a first device, configuration information associated with the moving IAB node, wherein the moving IAB node is moving and the configuration information comprises at least one of: a radio link control (RLC) channel of the moving IAB node, a RLC channel mapping rule of the moving IAB node, or a routing table of the moving IAB node.

In a third aspect, there is provided a communication method. The method comprises: receiving, at a first integrated access backhaul (IAB) node and from a donor centralized unit (CU) of a second IAB node, a radio condition for removing the second IAB node, wherein the second IAB node is a parent IAB node of the first IAB node and serves as a secondary node in a dual connection with the first IAB node; in accordance with a determination that the radio condition is satisfied, determining, at the first IAB node, to remove the second IAB node; and transmitting, to the donor CU, a removal indication regarding a removal of the second IAB node.

In a fourth aspect, there is provided a communication method. The method comprises: receiving, at a first integrated access backhaul (IAB) node and from a donor centralized unit (CU), configuration information associated with a second IAB node, wherein the first IAB node is moving to the second IAB node, and the configuration information comprises at least one of: a radio link control (RLC) channel of the second IAB node, a RLC channel mapping rule of the second IAB node, or a routing table of the second IAB node, the configuration information further comprises a radio condition for adding the second IAB node; and in accordance with a determination that the radio condition is satisfied, determining, at the first IAB node, to activate the second IAB node as a secondary node.

In a fifth aspect, there is provided a communication method. The method comprises: transmitting, at a donor centralized unit (CU) and to a first integrated access backhaul (IAB) node, first configuration information associated with a second IAB node, wherein the first IAB node is moving to the second IAB node, and the first configuration information comprises at least one of: a radio link control (RLC) channel of the second IAB node, RLC channel mapping rule of the second IAB node, or a routing table of the second IAB node.

In a sixth aspect, there is provided a first device. The first device comprises a processor; and a memory coupled to the processor and storing instructions thereon, the instructions, when executed by the processor, causing the first device to perform the method according to the first aspect.

In a seventh aspect, there is provided a second device. The second device comprises a processor; and a memory coupled to the processor and storing instructions thereon, the instructions, when executed by the processor, causing the second device to perform the method according to the second aspect.

In an eighth aspect, there is provided an IAB node. The IAB node comprises a processor; and a memory coupled to the processor and storing instructions thereon, the instructions, when executed by the processor, causing the IAB node to perform the method according to the third aspect.

In a ninth aspect, there is provided an IAB node. The IAB node comprises a processor; and a memory coupled to the processor and storing instructions thereon, the instructions, when executed by the processor, causing the IAB node to perform the method according to the fourth aspect.

In a tenth aspect, there is provided a donor CU. The donor CU comprises a processor; and a memory coupled to the processor and storing instructions thereon, the instructions, when executed by the processor, causing the donor CU to perform the method according to the fifth aspect.

In a twelfth aspect, there is provided a computer readable medium having instructions stored thereon, the instructions, when executed on at least one processor, causing the at least one processor to carry out the method according to any one of the first, second, third, fourth or fifth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. 1A and 1B shows schematic diagram of communication environments in which embodiments of the present disclosure can be implemented, respectively;

FIG. 2 illustrates a signaling flow for an inter-donor centralized unit (CU) master node/secondary node (MN/SN) exchange according to some embodiments of the present disclosure;

FIG. 3 illustrates a signaling flow for an intra-donor CU MN/SN exchange according to some embodiments of the present disclosure;

FIG. 4 illustrates a signaling flow for an autonomous removal of a SN parent node according to some embodiments of the present disclosure;

FIG. 5 illustrates a signaling flow for an autonomous addition of a SN parent node according to some embodiments of the present disclosure;

FIG. 6 illustrates a signaling flow for an F1-C mobility according to some embodiments of the present disclosure;

FIG. 7 is a flowchart of an example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure;

FIG. 11 is a flowchart of an example method in accordance with an embodiment of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As discussed above, if a communication device is moving in a high speed, the conventional handover of this communication device may not be applicable. For example, if an integrated access backhaul (IAB) node moves very fast, the IAB node may perform very frequently, which causes that end users may suffer high service interruption. Moreover,

[symbol]

Moreover, the technology “dual connectivity (DC)” can be introduced into the IAB. If the DC is applied, the IAB node is able to simultaneously transmit and receive data on multiple component carriers from two serving nodes (i.e., a master node (MN) and a secondary node (SN)). Compared to handover of IAB node, the DC for the IAB can reduce the service interruption.

Therefore, new solutions on MN/SN switch are needed. According to embodiments of the present disclosure, a first device transmits configuration information associated with a moving IAB node to a second device. The second device serves as a SN of the moving IAB node. The configuration information comprises at least one of: a radio link control (RLC) channel of the moving IAB node, a RLC channel mapping of the moving IAB node or a routing table of the moving IAB node. In this way, the service interruption can be minimized and mobility robustness is enhanced.

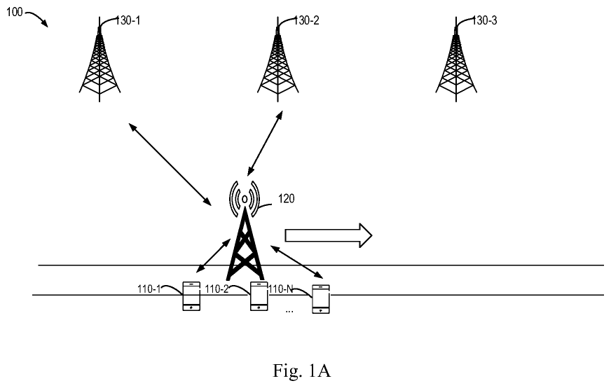

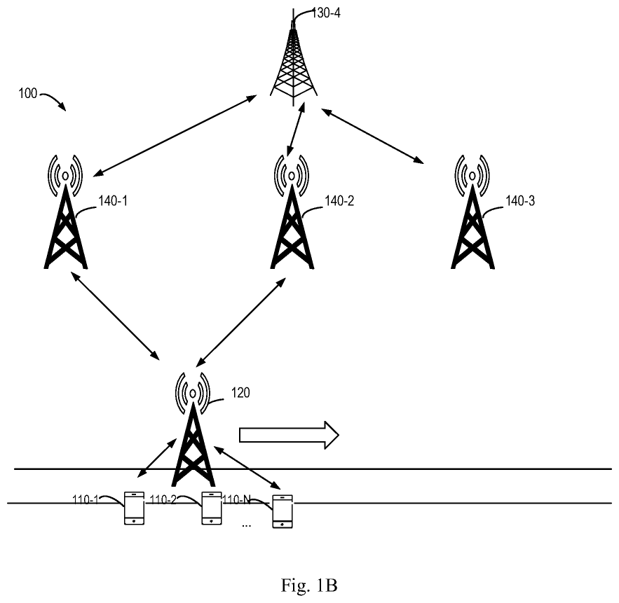

FIGS. 1A and 1B shows schematic diagram of communication environments in which embodiments of the present disclosure can be implemented, respectively. As shown in FIGS. 1A and 1B, the communication system 100, which is a part of a communication network, comprises a terminal device 110-1, a terminal device 110-2, . . . , a terminal device 110-N, which can be collectively referred to as “terminal device(s) 110.” The number N can be any suitable integer number. The communication system 100 further comprises an IAB node 120. As shown in FIGS. 1A and 1B, the IAB node 120 is a moving IAB node. The term “moving IAB node” used herein can refer to an IAB node which is moving or mounted on a moving object. For example, the IAB node 120 may be mounted on a high speed train or a high speed vehicle. In some embodiments, the IAB node 120 may be moving in a predetermined or predictable trajectory. As per the predetermined trajectory of an IAB node 120, the first device can predict the IAB node 120 will move to the coverage of the second device, in resulting the first device can add the second device as a SN of IAB node 120, and make decision to switch the roles of MN and SN. In some embodiments, the IAB node may be any suitable network device. The terminal device 110 the IAB node 120 can communicate data and control information to each other. The term “IAB node” used herein can refer to a node which may serve multiple radio sectors and is wireless backhauled to an IAB donor. The term “IAB node” used herein can refer to a network device that provides network access to UEs via a network of backhaul and access links and comprises a donor CU and one or more donor distributed units (DUs). The donor CU is the gNB-CU of an IAB donor, terminating an F1 interface towards IAB nodes and donor DU. The donor DU is the gNB-DU of the IAB donor, hosting the IAB backhaul adaptation protocol (BAP) layer, providing wireless backhaul to IAB nodes.

In some embodiments, as shown in FIG. 1A, the communication system 100 may also comprise one or more donors, for example, a donor CU 130-1, a donor CU 130-2 and a donor CU 130-3. In some embodiments, the IAB node 120 may have a dual connection with a donor CU 130-1 and a donor CU 130-2. Only as an example, the donor CU 130-1 may serve as a MN and the donor CU 130-2 may serve as a SN in this dual connectivity.

In some embodiments, as shown in FIG. 1B, the communication system 100 may comprise other IAB nodes, for example, an IAB node 140-1, an IAB node 140-2 and an IAB node 140-3. The IAB nodes 140-1, 140-2 and 140-3 may have a same donor centralized unit (CU) which is shown as the donor CU 130-4. As shown in FIG. 1B, the IAB node 120 may have a dual connection with the IAB node 140-1 and the IAB node 140-2. The IAB nodes 140-1 and 140-2 are parent IAB nodes of the IAB node 120. Only as an example, the donor 140-1 may serve as a MN and the donor 140-2 may serve as a SN in this dual connectivity.

It should be noted that the number of donors and the number of IAB nodes shown in FIGS. 1A and 1B are only examples. The donor can also communicate with the IAB node 120. Only for the purpose of illustrations, the IAB node 120-2 can be handed over from the IAB node 120-3 to the IAB node 120-3.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

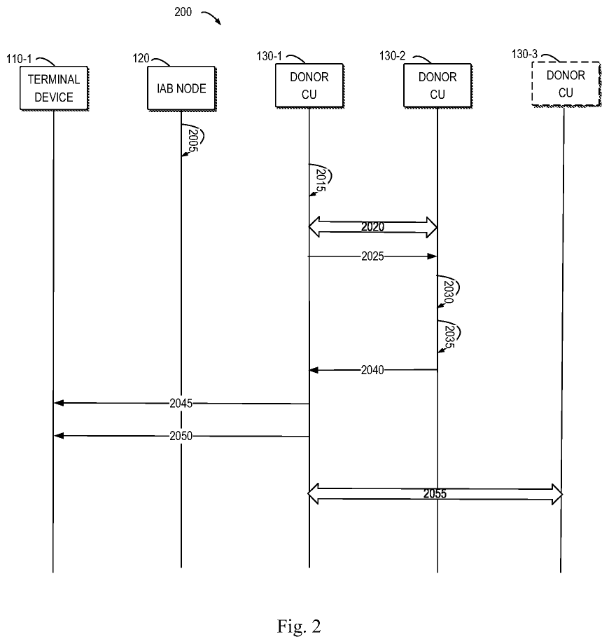

Embodiments of the present disclosure will be described in detail below. Reference is first made to FIG. 2, which shows a signaling chart illustrating process 200 for an inter-donor CU MN/SN exchange according to some example embodiments of the present disclosure. Only for the purpose of discussion, the process 200 will be described with reference to FIG. 1A. The process 200 may involve the terminal device 110-1, the IAB node 120, the donor CU 130-1, and the donor CU 130-2 in FIG. 1. In some embodiments, the process 200 may the donor CU 130-3. In this case, if the MN and SN are changed, the RRC and packet data convergence protocol (PDCP) need to be re-configured.

The IAB node 120 may measure 2005 signal quality on a first link between the IAB node 120 and the donor CU 130-1 and a second link between the IAB node 120 and the donor CU 130-2. For example, the IAB node 120 may measure a reference signal received power (RSRP). Alternatively or in addition, the IAB node may measure a reference signal received quality (RSRQ).

The IAB node 120 may transmit 2010 the measurement report to the donor CU 130-1. For example, the measurement report may indicate the measured RSRP of the first link and/or the second link. Alternatively or in addition, the measurement report may indicate the measured RSRQ of the first link and/or the second link.

The donor CU 130-1 may determine 2015 to add the donor CU 130-2 as the SN based on the measurement report. For example, if the measurement report indicates that the measured RSRP of the second link exceeds a threshold value, the donor CU 130-1 can determine that the donor CU 130-2 can be added. Alternatively or in addition, if the measurement report indicates that the measured RSRQ of the second link exceeds a threshold value, the donor CU 130-1 can determine that the donor CU 130-2 can be added.

The donor CU 130-1 may perform 2020 a SN addition procedure to add the donor CU 130-2. The donor CU 130-1 can establish a redundant path for the IAB node 120. The redundant path can be established according to any proper procedure, for example, the procedure for adding secondary cell group and redundant rout shown in TS 38.874. The IAB node 120 is connecting with the donor CU 130-1 and the donor CU 130-2. The donor CU 130-1 can be currently serving as the MN and the donor CU 130-2 can be currently serving as the SN.

If the IAB node 120 is moving from the donor CU 130-1 to the donor CU 130-2, the MN and SN need to be changed. For example, the IAB node 120 may be moving closer to the donor CU 130-2 and farther from the donor CU 130-1. In this scenario, the signal quality on the second link may become better and the signal quality on the first link may become worse.

The donor CU 130-1 transmits 2025 a MN/SN switch request to the donor CU 130-2. In other embodiments, according to the predetermined trajectory of the IAB node 120, the donor CU 130-1 may predict that the IAB node 120 will move to the coverage of the donor CU 130-2 and can add the donor CU 130-2 as the SN of the IAB node 120. Thereby, the donor CU 130-1 can make decision to switch roles of MN and SN.

The MN/SN switch request is used to change the current MN to be SN and the current SN to be MN. The MN/SN switch request comprises configuration information of the IAB node 120. The configuration information can comprise one or more of: a RLC channel of the IAB node 120, a RLC channel mapping rule of the IAB node 120, and a routing table of the IAB node 120. In some embodiments, the MN/SN switch request may comprise an identity list of a set of terminal devices which connects to the IAB node 120. For example, the MN/SN switch request may comprise the ID of the terminal device 110-1. The ID can be used to identity both the terminal device 110-1 and/or the IAB node 120. Alternatively or in addition, the MN/SN switch request may comprise a first indication regarding that the donor CU 130-1 will be changed to the SN. The MN/SN switch request may comprise a second indication regarding that the donor CU 130-2 will be changed to the MN. In some embodiments, the MN/SN switch request may comprise a radio resource control (RRC) container of the donor CU 130-1. In some embodiments, the RRC container may comprise a system information block (SIB) configuration. Alternatively or in addition, the RRC container may comprise signaling radio bearer (SRB) configuration(s). For example, the RRC container may comprise one or more of: SRB0, SRB 1 and SRB 2. SRB 0 can be for RRC messages using a common control channel (CCCH) logical channel. SRB 1 can be for RRC messages (which may include a piggybacked non-access stratum (NAS) message) as well as for NAS messages prior to an establishment of SRB 2, all using dedicated control channel (DCCH) logical channel. SRB 2 can be for NAS messages, all using DCCH logical channel. SRB2 can have a lower-priority than SRB1 and is always configured by the network after security activation. SRB3 can be for specific RRC messages when UE is in EN-DC (Evolved-Universal Terrestrial Radio Access-New Radio Dual Connectivity), all using DCCH logical channel.

After receiving the MN/SN switch request, the donor CU 130-2 can apply 2030 the MN change. For example, the donor CU 130-2 may apply the RRC configuration in the MN/SN switch request. The donor CU 130-2 may establish 2035 a data radio bearer (DRB) and/or RLC channel of the IAB node 120. The donor CU 130-2 may allocate resources for the DRB and/or RLC. In some embodiments, the donor CU 130-2 may establish the RLC channel of the IAB node 120 based on the MN/SN switch request. For example, the donor CU 130-2 may successfully establish all of the RLC channels in the MN/SN switch request. Alternatively, the donor CU 130-2 may only successfully establish some one of the RLC channels in the MN/SN switch request.

The donor CU 130-2 transmits 2040 a MN/SN switch response to the donor CU 130-1. The MN/SN switch response may comprise at least one RLC channel of the IAB node 120 which is successfully established by the donor CU 130-2. For example, if all RLC channels indicated in the MN/SN switch request can be established, the MN/SN switch response may comprise all of the RLC channels. Alternatively, if only some of RLC channels indicated in the MN/SN switch request can be established, the MN/SN switch response may comprise the successfully established RLC channels. In some embodiments, the MN/SN switch response may comprise a RLC channel mapping rule of the donor 130-2. Alternatively or in addition, the MN/SN switch response may comprise a routing table of the donor 130-2. In other embodiments, the MN/SN switch response may comprise an identity list of a set of terminal devices, for example, the terminal device 110. The set of terminal devices may be connecting to the IAB node 120. The term “RLC channel mapping rule” used herein can refer to a mapping between a RLC channel and a UE radio bearer, or how a RLC channel is mapped from an ingress IAB backhaul link to an egress IAB backhaul link.

The donor CU 130-1 may transmit 2045 a RRC Reconfiguration to the terminal device 110-1 to configure SRBs, for example, to move SRB1/2 to the donor CU 130-2 and the move SRB3 to the donor CU 130-1. The donor CU 130-1 may also transmit 2050 a RRC Reconfiguration to the terminal device 110-1 to configure DRBs, for example, to move DRB to the donor CU 130-2.

In some embodiments, after the IAB node 120 moves the donor 130-3, the SN change procedure can be performed 2055. A UE context/IAB context can be transferred from the donor CU 130-1 (i.e., the source SN) to the donor CU 130-3 (i.e., the target SN) to change the SCG configuration.

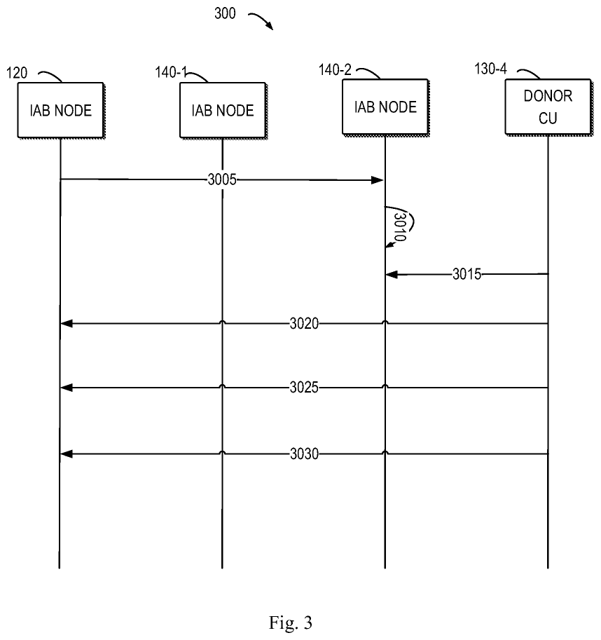

Embodiments of the present disclosure will be described in detail below. Reference is first made to FIG. 3, which shows a signaling chart illustrating process 300 for an intra-donor CU MN/SN exchange according to some example embodiments of the present disclosure. Only for the purpose of discussion, the process 300 will be described with reference to FIG. 1B. The process 300 may involve the IAB node 120, the IAB node 140-1, the IAB node 140-2, and the donor CU 130-4 in FIG. 1. In this case, if the MN and SN are changed, the RRC and packet data convergence protocol (PDCP) does not need to be re-configured.

The IAB node 120 may indicate 3005 a random access procedure to the IAB node 140-2. The random access procedure can be any proper procedure. For example, the IAB node 120 may automatously determine to add the IAB node as its SN. Alternatively, the donor 130-4 may determine that the IAB node 120 needs to access to the IAB node 140-2.

The IAB node 140-2 may establish 3010 a redundant path as a SN parent node of the IAB node 120 with the donor CU 130-4. The donor CU 130-4 transmits 3015 a redundant path addition response to the IAB node 140-2. The redundant path addition response comprises the configuration of the IAB node 120. The configuration information can comprise one or more of: a RLC channel of the IAB node 120, a RLC channel mapping rule of the IAB node 120, and a routing table of the IAB node 120. The redundant path addition response may comprise an identity list of a set of terminal devices which connects to the IAB node 120. For example, the redundant path addition response may comprise the ID of the terminal device 110-1. Alternatively or in addition, the redundant path addition response may comprise an identity of the IAB node 120.

In other embodiments, according to the predetermined trajectory of the IAB node 120, the IAB node 140-1 may predict that the IAB node 120 will move to the coverage of the IAB node 140-2 and can add the IAB node 140-2 as the SN of the IAB node 120. Thereby, the IAB node 140-1 can make decision to switch roles of MN and SN.

In some embodiments, if the MN/SN parent node switch is prepared or the MN/SN switched is to be performed, the donor CU 130-4 may transmit 3020 a UE context modification to the IAB node 120 to configure the RLC channel mapping rule. The IAB node 120 receives the UE context modification from the donor CU 130-4.

In addition, if the MN/SN parent node switch is prepared or the MN/SN switched is to be performed, the donor CU 130-4 may transmit 3025 a BAP Mapping configuration to the IAB node 120 to configure the routing table. The IAB node 120 receives the BAP Mapping configuration from the donor CU 130-4.

The donor CU 130-4 may transmit 3030 a MN/SN switch message to the IAB node 120. In other words, the IAB node 120 may receive the MN/SN switch message from the donor CU 1304. The MN/SN switch message may comprise an indication regarding that the IAB node 140-1 will be changed to be the SN. In addition, the MN/SN switch message may comprise another indication regarding that the IAB node 140-2 will be changed to be the MN. The IAB node 140-2 is switched to the main path (i.e., the MN) and the IAB node 140-1 is switched the redundant path (i.e., the SN). The IAB node 120 may transmit uplink data to the donor CU 130-4 via the IAB node 140-2. In some embodiments, the redundant path only used in case of RLC occurs in the main path. Alternatively or in addition, the redundant path can be further used for offloading.

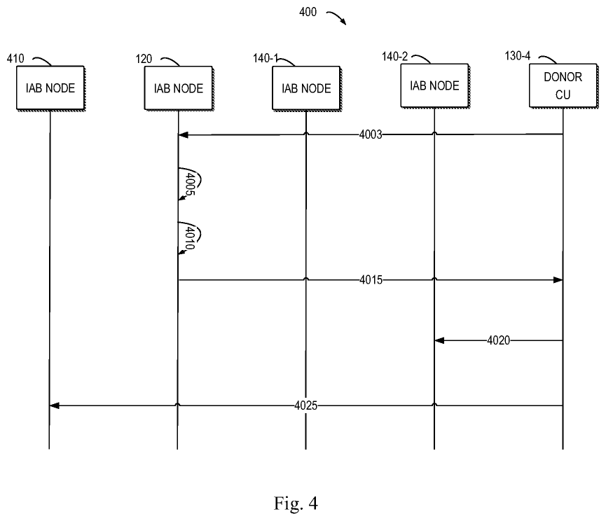

Embodiments of the present disclosure will be described in detail below. Reference is first made to FIG. 4, which shows a signaling chart illustrating process 400 for an autonomous removal of SN according to some example embodiments of the present disclosure. Only for the purpose of discussion, the process 400 will be described with reference to FIG. 1B. The process 400 may involve the IAB node 120, the donor CU 140-1, the donor CU 140-2, and the donor CU 130-4 in FIG. 1B. The process 400 may also involve the IAB node 410 and the IAB node 120 is the parent IAB node of the IAB node 410.

The donor CU 130-4 may transmit 4003 a radio condition for removing the IAB node 140-2. In some embodiments, the radio condition can be a RSRP threshold. Alternatively or in addition, the radio condition can be a RSRQ threshold.

The IAB node 120 determines 4005 to remove the IAB node 140-2 if the radio condition is satisfied. For example, if the RSRP of the IAB node 140-2 is below the RSRP threshold, the IAB node 120 may determine to remove the IAB node 140-2. Alternatively, if the RSRQ of the IAB node 140-2 is below the RSRQ threshold, the IAB node 120 may determine to remove the IAB node 140-2. In this way, the IAB node can be removed as soon as possible.

The IAB node 120 may reroute 4010 one or more BAP protocol data units (PDUs) received from the IAB node 410 if those BAP PDUs were routed to the IAB node 140-2. The one or more BAP PDUs may be rerouted to the IAB node 140-1 which is the other parent IAB node of the IAB node 120 and serves as the MN.

The IAB node 120 transmits 4015 a removal indication to the donor CU 130-4 to inform a removal of the IAB node 140-2. The donor CU 130-4 may transmit 4020 a UE context medication message to IAB node 140-2 to remove the context of the IAB node 120. The donor CU 130-4 may transmit 4025 BAP mapping configuration to the IAB node 410 to update the routing table towards IAB node 140-2 to be towards IAB node 140-1.

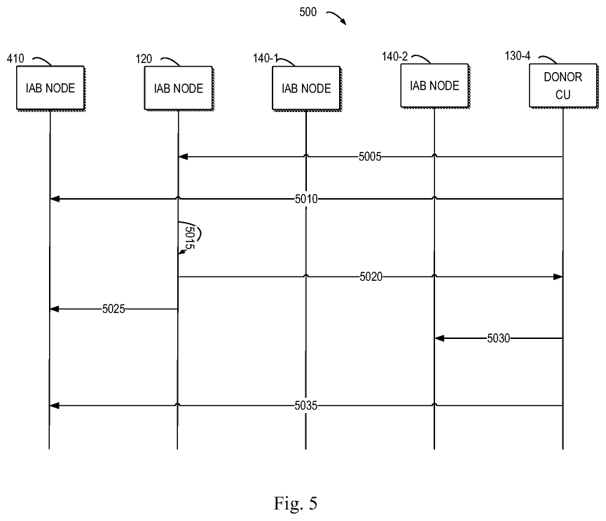

Embodiments of the present disclosure will be described in detail below. Reference is first made to FIG. 5, which shows a signaling chart illustrating process 500 for an autonomous addition of SN according to some example embodiments of the present disclosure. Only for the purpose of discussion, the process 500 will be described with reference to FIG. 1B. The process 500 may involve the IAB node 120, the donor CU 140-1, the donor CU 140-2, and the donor CU 130-4 in FIG. 1B. The process 500 may also involve the IAB node 410 and the IAB node 120 is the parent IAB node of the IAB node 410.

The donor CU 130-4 may determine that the IAB node 120 is moving to the IAB node 140-2 based on a measurement report from the IAB node 120. The measurement report can comprise any suitable type of report.

The donor CU 130-4 transmits 5005 configuration information associated with the IAB node 140-2. The configuration information can comprise one or more of: a RLC channel of the IAB node 140-2, a RLC channel mapping rule of the IAB node 140-2, and a routing table of the IAB node 140-2. The configuration information also comprises a radio condition for adding the IAB node 140-2. In some embodiments, the radio condition can be a RSRP threshold. Alternatively or in addition, the radio condition can be a RSRQ threshold.

In some embodiments, the donor CU 130-4 may transmit 5010 second configuration information associated with the IAB node 140-2 to the IAB node 410. The second configuration information can comprise one or more of: a RLC channel of the IAB node 140-2, a RLC channel mapping rule of the IAB node 140-2, and a further routing table which indicates rerouting a path of an old routing identify to a new routing identity of the second IAB node.

If the radio condition indicated in the configuration information is satisfied, the IAB node 120 determines 5015 to activate the IAB node 140-2 as the SN. For example, if the RSRP of the IAB node 140-2 exceeds the RSRP threshold, the IAB node 120 may determine to add the IAB node 140-2. Alternatively, if the RSRQ of the IAB node 140-2 exceeds the RSRQ threshold, the IAB node 120 may determine to add the IAB node 140-2. In this way, the IAB node can be added as soon as possible.

The IAB node may transmit 5020 a SN addition indication to the donor CU 130-4 to inform the addition of the IAB node 140-2. It should be noted that the transmission (5010) of the second configuration information can be after the determination of activating the IAB node (5015) or after the transmission (5020) of the SN addition indication.

The IAB node may transmit 5025 an indication to the IAB node 410 to inform the IAB node 410 to apply the new routing table of the IAB node 140-2 in accordance with the old routing ID. The donor CU 130-4 may transmit 5030 a UE context modification message to the IAB node 140-2 to add the context of the IAB node 120.

In some embodiments, if there is no transmission (5010) of the second configuration information and no transmission (5025) of the indication, the donor CU 130-4 may transmit 5035 BAP mapping configuration to the IAB node 410 to update the routing table.

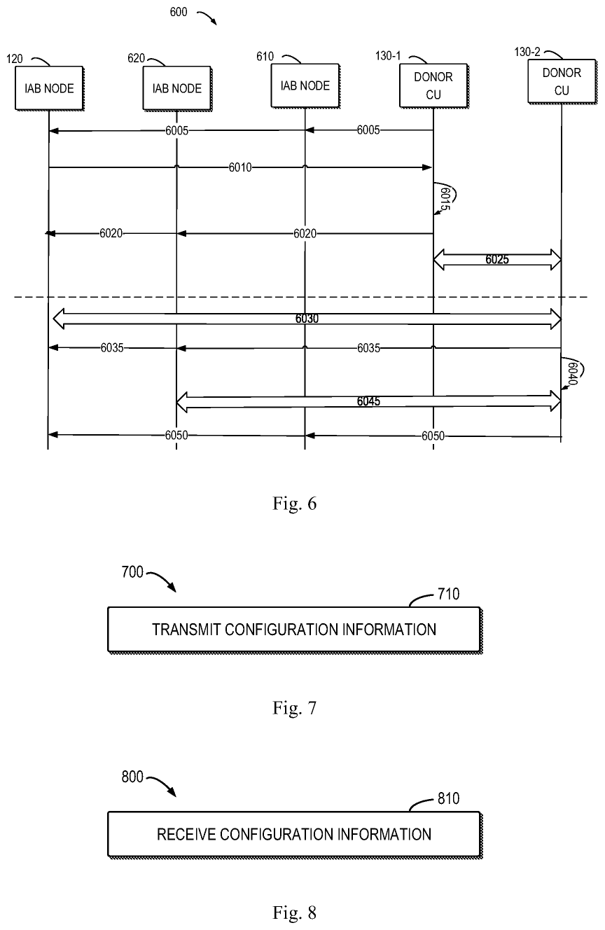

Embodiments of the present disclosure will be described in detail below. Reference is first made to FIG. 6, which shows a signaling chart illustrating process 600 for F1-C mobility in redundant path configuration according to some example embodiments of the present disclosure. Only for the purpose of discussion, the process 600 will be described with reference to FIG. 1A. The process 600 may involve the IAB node 120, the donor CU 130-1, and the donor CU 130-2 in FIG. 1A. The process 600 may also involve the IAB node 610 and the IAB node 620. The donor CU 130-2 is non-F1-Terminated CU, which transmits F1-U data to the IAB node 120 via the IAB node 610 and/or the IAB node 620.

The donor CU 130-1 may transmit 6005 an F1-C message to the IAB node 120 via the IAB node 610. When the IAB node 120 is moving to the IAB node 620 which is farther to the IAB node 120, the IAB node 120 may transmit 6010 a measurement report to the donor CU 130-1 which is the F1-terminated CU and is also the anchor node of RRC as an MN.

The donor CU 130-1 may determine 6015 to offload some of the F1-C messages via the IAB node 620. The donor CU 130-1 may transmit 6020 the F1-C messages to the IAB node 120 via the IAB node 620. If the MN/SN switch is performed, the F1-terminated CU and non-F1-terminated CU exchange their roles.

During an intra-CU F1 message migration procedure, the donor CU 130-2 may establish 6030 SRB2 with the IAB node 120 MT via the IAB node 620. The donor CU 130-2 may transmit 6035 F1-C messages via SRB2 of the IAB node 620 to the IAB node 120.

After receiving the measurement report from the IAB node 120 MT, the donor CU 130-2 may determine 6040 to offload F1-C messages to the IAB 610 DU1. The donor CU 130-2 may establish 6045 SRB2 with the IAB node 620 MT via the IAB node 610. The donor CU 130-2 may transmit 6050 the F1-C messages via SRB 1 of the IAB node 610 to the IAB node 120.

In some embodiments, the processes 200, 300, 400, 500 and 600 can be implemented separately in different embodiments. Alternatively, the processes 200, 300, 400, 500 and 600 can be implemented in a combined manner. For example, the automatous addition of the SN can be applied in the processes 200 and/or 300. Alternatively or in addition, the automatous removal of the SN can be applied in the processes 200 and/or 300.

FIG. 7 shows a flowchart of an example method 700 in accordance with an embodiment of the present disclosure. The method 700 can be implemented at any suitable devices. Only for the purpose of illustrations, the method 700 can be implemented at a first device. The first device may refer to different devices according to different embodiments.

At block 710, the first device transmits, to a second device, configuration information associated with a moving IAB node, for example, the IAB node 120. The second device serves as a SN of the IAB node 120. For example, the IAB node 120 may be moving towards the second device. Alternatively or in addition, the IAB node 120 may be moving along a predetermined trajectory. As per the predetermined trajectory of the IAB node 120, the first device can predict the IAB node 120 will move to the coverage of the second device, in resulting the first device can add the second device as a SN of IAB node 120, and make decision to switch the roles of MN and SN. The configuration information comprises at least one of: a RLC channel of the moving IAB node, a RLC channel mapping rule of the moving IAB node, or a routing table of the moving IAB node.

In some embodiments, the moving IAB node has a dual connection with the first device and the second device, the first device is a first donor centralized unit (CU) and serves as a master node (MN), and the second device is a second donor CU. In this case, the first device may transmit, to the second device, a MN/SN switch request which comprises the configuration information. The MN/SN request further comprises at least one of: an identity list of a set of terminal devices, the set of terminal devices connecting to the moving IAB node, a first indication regarding that the first device is to change to the SN, a second indication regarding that the second device is to change to the MN, or a radio resource control (RRC) container of the first device. In some embodiments, the first device may receive, from the second device, a MN/SN switch response. The MN/SN switch response comprises at least one of: at least one established RLC channel of the moving IAB node, a RLC channel mapping rule of the second device, a routing table of the second device, or an identity list of a set of terminal devices, the set of terminal devices connecting to the moving IAB node. Alternatively or in addition, the first device may change from an F1-terminated (F1-T) CU to a non F1-T CU.

In some embodiments, the first device has a dual connection with the second device and a first parent IAB node which serves as a MN, the second device is a second parent IAB node, and the first device is a donor centralized unit (CU) of the first parent IAB node and the second parent IAB node. In this case, the first device may transmit, to the second device, a redundant path addition response comprising the configuration information. The redundant path addition response further comprises: a first identity of the moving IAB node, or a second identity a terminal device which connects with the moving IAB node.

In some embodiments, if a MN/SN switch is to be performed, the first device may transmit, to the moving IAB node, a UE context modification message to configure the RLC channel mapping rule. Alternatively or in addition, if a MN/SN switch is to be performed, the first device may transmit, to the moving IAB node, a backhaul adaption protocol (BAP) mapping configuration to configure the routing table. In some embodiments, the first device may transmit, to the moving IAB node, a MN/SN switch message. The MN/SN with message may comprise a third indication regarding that the first parent IAB node is to change to the SN, and a fourth indication regarding that the second parent IAB node is change to the MN.

FIG. 8 shows a flowchart of an example method 800 in accordance with an embodiment of the present disclosure. The method 800 can be implemented at any suitable devices. Only for the purpose of illustrations, the method 800 can be implemented at a second device. The second device may be the donor CU 130-2 in FIG. 1A. Alternatively, the second device may be the donor CU 140-2 in FIG. 1B.

At block 810, the second device receives, from a first device, configuration information associated with the moving IAB node, for example, the IAB node 120. The second device serves as a SN of the moving IAB node. For example, the IAB node 120 may be moving towards the second device. Alternatively or in addition, the IAB node 120 may be moving along a predetermined trajectory. As per the predetermined trajectory of the IAB node 120, the first device can predict the IAB node 120 will move to the coverage of the second device, in resulting the first device can add the second device as a SN of IAB node 120, and make decision to switch the roles of MN and SN. The configuration information comprises at least one of: a RLC channel of the moving IAB node, a RLC channel mapping rule of the moving IAB node, or a routing table of the moving IAB node.

In some embodiments, the moving IAB node has a dual connection with the first device and the second device, the first device is a first donor CU and serves as a master node (MN), and the second device is a second donor CU and serves as a secondary node (SN). In this case, the second device may receive, from the first device, a MN/SN switch request comprising the configuration information. The MN/SN request further comprises at least one of: an identity list of a set of terminal devices, the set of terminal devices connecting to the moving IAB node, a first indication regarding that the first device is to change to the SN, a second indication regarding that the second device is change to the MN, or a RRC container of the first device. In some embodiments, the second device may transmit, to the first device, a MN/SN switch response. The MN/SN switch response may comprise at least one of: at least one established RLC channel of the moving IAB node, the RLC channel mapping rule of the second device, a routing table of the second device, or an identity list of a set of terminal devices, the set of terminal devices connecting to the moving IAB node.

In some embodiments, the moving IAB node may have a dual connection with a first parent IAB node which serves as a MN and a second parent IAB node. The second device is regarded as the second parent IAB node, and the first device is a donor centralized unit (CU) of the first parent IAB node and the second parent IAB node. In this case, the second device may receive, from the first device, a redundant path addition response comprising the configuration information. The redundant path addition response may further comprise: a first identity of the moving IAB node, or a second identity a terminal device which connects with the moving IAB node. In some embodiments, the second device may change, from a non F1-terminated (F1-T) CU to an F1-T CU.

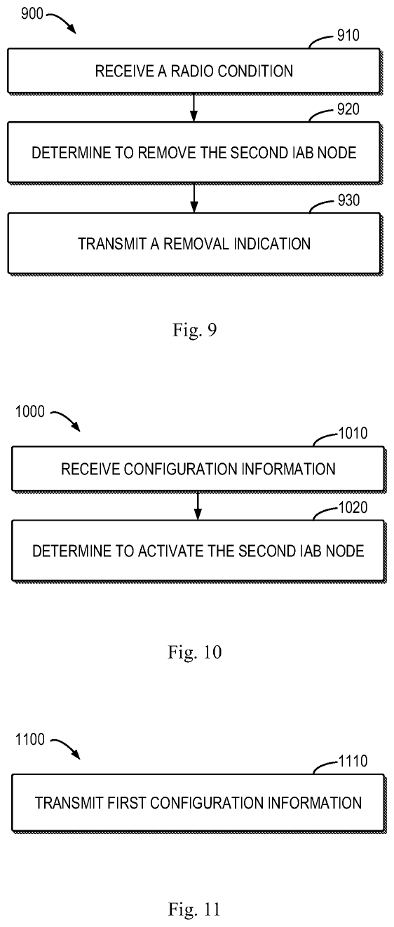

FIG. 9 shows a flowchart of an example method 900 in accordance with an embodiment of the present disclosure. The method 900 can be implemented at any suitable devices. Only for the purpose of illustrations, the method 900 can be implemented at the IAB node 120 as shown in FIGS. 1A and 1B.

At block 910, the first IAB node receives, from a donor centralized unit (CU) of a second IAB node, a radio condition for removing the second IAB node. The second IAB node is a parent IAB node of the first IAB node and serves as a secondary node in a dual connection with the first IAB node.

At block 920, if the radio condition is satisfied, the first IAB node determines to remove the second IAB node.

At block 930, the first IAB node transmits, to the donor CU, a removal indication regarding a removal of the second IAB node.

In some embodiments, the first IAB node may receive, from a third IAB node, a set of backhaul adaption protocol (BAP) PDUs which are routed to the second IAB node. The first IAB node may reroute the set of BAP PDUs to a fourth IAB, wherein the fourth IAB node is another parent IAB node of the first IAB node and serves as a master node in the dual connection with the first IAB node.

FIG. 10 shows a flowchart of an example method 1000 in accordance with an embodiment of the present disclosure. The method 1000 can be implemented at any suitable devices. Only for the purpose of illustrations, the method 1000 can be implemented at the IAB node 120 as shown in FIGS. 1A and 1B.

At block 1010, the first IAB node receives, from a donor centralized unit (CU), configuration information associated with a second IAB node. The first IAB node is moving to the second IAB node. The configuration information comprises at least one of: a radio link control (RLC) channel of the second IAB node, a RLC channel mapping rule of the second IAB node, or a routing table of the second IAB node, the configuration information further comprises a radio condition for adding the second IAB node.

At block 1020, if the radio condition is satisfied, the first IAB node determines to activate the second IAB node as a secondary node.

In some embodiments, the first IAB node may transmit, to the donor CU, a SN addition indication regarding an addition of the second IAB node.

In some embodiments, the first IAB node may transmit, to a third IAB node, an indication to apply the routing table of the second IAB node, wherein the first IAB node is a parent IAB node of the third IAB node.

FIG. 11 shows a flowchart of an example method 1100 in accordance with an embodiment of the present disclosure. The method 1100 can be implemented at any suitable devices. Only for the purpose of illustrations, the method 1100 can be implemented at the donor CU 130-4 as shown in FIG. 1B.

At block 1110, the donor CU transmits, to a first integrated access backhaul (IAB) node, first configuration information associated with a second IAB node. The first IAB node is moving to the second IAB node. The first configuration information comprises at least one of: a radio link control (RLC) channel of the second IAB node, RLC channel mapping rule of the second IAB node, or a routing table of the second IAB node.

In some embodiments, the donor CU may receive, from the first IAB node, an SN addition indication regarding an addition of the second IAB node.

In some embodiments, the donor CU may transmit, at the donor CU to a third IAB node, second configuration information associated with the second IAB node. The first IAB node is a parent IAB node of the third IAB node. The second configuration information may comprise at least one of: a RLC channel of the second IAB node, a RLC channel mapping rule of the second IAB node, or a further routing table which indicates rerouting a path of an old routing identify to a new routing identity of the second IAB node.

In some embodiments, the donor CU may transmit, to a third IAB node, an indication to apply the routing table of the second IAB node, wherein the first IAB node is a parent IAB node of the third IAB node.

In some embodiments, a first device comprises circuitry configured to: transmit, at a first device and to a second device which serves as a secondary node (SN) of a moving integrated access backhaul (IAB) node, configuration information associated with the moving IAB node, wherein the configuration information comprises at least one of: a radio link control (RLC) channel of the moving IAB node, a RLC channel mapping rule of the moving IAB node, or a routing table of the moving IAB node.

In some embodiments, the moving IAB node has a dual connection with the first device and the second device, the first device is a first donor centralized unit (CU) and serves as a master node (MN), and the second device is a second donor CU.

In some embodiments, the first device comprises circuitry configured to transmit the configuration information by: transmitting, to the second device, a MN/SN switch request comprising the configuration information, and wherein the MN/SN request further comprises at least one of: an identity list of a set of terminal devices, the set of terminal devices connecting to the moving IAB node, a first indication regarding that the first device is to change to the SN, a second indication regarding that the second device is to change to the MN, or a radio resource control (RRC) container of the first device.

In some embodiments, the first device comprises circuitry configured to receive, from the second device, a MN/SN switch response, wherein the MN/SN switch response comprises at least one of: at least one established RLC channel of the moving IAB node, a RLC channel mapping rule of the second device, a routing table of the second device, or an identity list of a set of terminal devices, the set of terminal devices connecting to the moving IAB node.

In some embodiments, the first device comprises circuitry configured to change, at the first device, from an F1-terminated (F1-T) CU to a non F1-T CU.

In some embodiments, the moving IAB node has a dual connection with a first parent IAB node which serves as a MN and a second parent IAB node, the second device is the second parent IAB node, and the first device is a donor centralized unit (CU) of the first parent IAB node and the second parent IAB node.

In some embodiments, the first device comprises circuitry configured to transmit the configuration information by: transmitting, to the second device, a redundant path addition response comprising the configuration information, and wherein the redundant path addition response further comprises: a first identity of the moving IAB node.

In some embodiments, the first device comprises circuitry configured to in accordance with a determination that a MN/SN switch is to be performed, transmit, to the moving IAB node, a UE context modification message to configure the RLC channel mapping rule.

In some embodiments, the first device comprises circuitry configured to in accordance with a determination that a MN/SN switch is to be performed, transmit, to the moving IAB node, a backhaul adaption protocol (BAP) mapping configuration to configure the routing table.

In some embodiments, the first device comprises circuitry configured to transmit, to the moving IAB node, a MN/SN switch message, wherein the MN/SN with message comprises: a third indication regarding that the first parent IAB node is to change to the SN, and a fourth indication regarding that the second parent IAB node is change to the MN.

In some embodiments, a second device comprises circuitry configured to receive, from a first device, configuration information associated with the moving IAB node, wherein the configuration information comprises at least one of: a radio link control (RLC) channel of the moving IAB node, a RLC channel mapping rule of the moving IAB node, or a routing table of the moving IAB node.

In some embodiments, the moving IAB node has a dual connection with the first device and the second device, the first device is a first donor CU and serves as a master node (MN), and the second device is a second donor CU and serves as a secondary node (SN).

In some embodiments, the second device comprises circuitry configured to receive the configuration information by: receiving, from the first device, a MN/SN switch request comprising the configuration information, and wherein the MN/SN request further comprises at least one of: an identity list of a set of terminal devices, the set of terminal devices connecting to the moving IAB node, a first indication regarding that the first device is to change to the SN, a second indication regarding that the second device is change to the MN, or a radio resource control (RRC) container of the first device.

In some embodiments, the second device comprises circuitry configured to transmit, to the first device, a MN/SN switch response, wherein the MN/SN switch response comprises at least one of: at least one established RLC channel of the moving IAB node, the RLC channel mapping rule of the second device, a routing table of the second device, or an identity list of a set of terminal devices, the set of terminal devices connecting to the moving IAB node.

In some embodiments, the moving IAB node has a dual connection with a first parent IAB node which serves as a MN and a second parent IAB node, the second device is the second parent IAB node, and the first device is a donor centralized unit (CU) of the first parent IAB node and the second parent IAB node.

In some embodiments, the second device comprises circuitry configured to receive the configuration information by: receiving, from the first device, a redundant path addition response comprising the configuration information, and wherein the redundant path addition response further comprises: a first identity of the moving IAB node.

In some embodiments, the second device comprises circuitry configured to change, at the second device, from a non F1-terminated (F1-T) CU to an F1-T CU.

In some embodiments, a first integrated access backhaul (IAB) node comprises circuitry configured to receive, from a donor centralized unit (CU) of a second IAB node, a radio condition for removing the second IAB node. The second IAB node is a parent IAB node of the first IAB node and serves as a secondary node in a dual connection with the first IAB node; in accordance with a determination that the radio condition is satisfied, determine, at the first IAB node, to remove the second IAB node; and transmit, to the donor CU, a removal indication regarding a removal of the second IAB node.

In some embodiments, the first IAB node comprises circuitry configured to receive, from a third IAB node, a set of backhaul adaption protocol (BAP) PDUs which are routed to the second IAB node; reroute the set of BAP PDUs to a fourth IAB, wherein the fourth IAB node is another parent IAB node of the first IAB node and serves as a master node in the dual connection with the first IAB node.

In some embodiments, a first integrated access backhaul (IAB) node comprises circuitry configured to receive, from a donor centralized unit (CU), configuration information associated with a second IAB node, wherein the first IAB node is moving to the second IAB node, and the configuration information comprises at least one of: a radio link control (RLC) channel of the second IAB node, a RLC channel mapping rule of the second IAB node, or a routing table of the second IAB node, the configuration information further comprises a radio condition for adding the second IAB node; in accordance with a determination that the radio condition is satisfied, determining, at the first IAB node, to activate the second IAB node as a secondary node.

In some embodiments, the first IAB node comprises circuitry configured to transmit, to the donor CU, an SN addition indication regarding an addition of the second IAB node.

In some embodiments, the first IAB node comprises circuitry configured to transmit, to a third IAB node, an indication to apply the routing table of the second IAB node, wherein the first IAB node is a parent IAB node of the third IAB node.

In some embodiments, a donor CU comprises circuitry configured to transmit, to a first integrated access backhaul (IAB) node, first configuration information associated with a second IAB node, wherein the first IAB node is moving to the second IAB node, and the first configuration information comprises at least one of: a radio link control (RLC) channel of the second IAB node, RLC channel mapping rule of the second IAB node, or a routing table of the second IAB node.

In some embodiments, the donor CU comprises circuitry configured to receive, from the first IAB node, an SN addition indication regarding an addition of the second IAB node.

In some embodiments, the donor CU comprises circuitry configured to transmit, to a third IAB node, second configuration information associated with the second IAB node, wherein the first IAB node is a parent IAB node of the third IAB node, and the second configuration information comprises at least one of: a RLC channel of the second IAB node, a RLC channel mapping rule of the second IAB node, or a further routing table which indicates rerouting a path of an old routing identify to a new routing identity of the second IAB node.

In some embodiments, the donor CU comprises circuitry configured to transmit, to a third IAB node, an indication to apply the routing table of the second IAB node, wherein the first IAB node is a parent IAB node of the third IAB node.

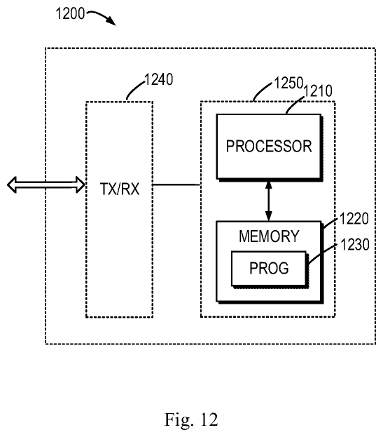

FIG. 12 is a simplified block diagram of a device 1200 that is suitable for implementing embodiments of the present disclosure. The device 1200 can be considered as a further example implementation of the IAB node 120 or the donor CUs as shown in FIG. 1. Accordingly, the device 1200 can be implemented at or as at least a part of the IAB node 120 or the donor CUs.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method, comprising:
transmitting, at a first device and to a second device which serves as a secondary node (SN) of a moving integrated access backhaul (IAB) node, configuration information associated with the moving IAB node, and the configuration information comprises at least one of: a radio link control (RLC) channel of the moving IAB node, a RLC channel mapping rule of the moving IAB node, or a routing table of the moving IAB node.

2. The method of claim 1, wherein the moving IAB node has a dual connection with the first device and the second device, the first device is a first donor centralized unit (CU) and serves as a master node (MN), and the second device is a second donor CU.

3. The method of claim 2, wherein transmitting the configuration information comprises:
transmitting, to the second device, a MN/SN switch request comprising the configuration information, and
wherein the MN/SN request further comprises at least one of:
an identity list of a set of terminal devices, the set of terminal devices connecting to the moving IAB node,
a first indication regarding that the first device is to change to the SN,
a second indication regarding that the second device is to change to the MN, or
a radio resource control (RRC) container of the first device.

4. The method of claim 2, further comprising:
receiving, from the second device, a MN/SN switch response, wherein the MN/SN switch response comprises at least one of:
at least one established RLC channel of the moving IAB node,
a RLC channel mapping rule of the second device,
a routing table of the second device, or
an identity list of a set of terminal devices, the set of terminal devices connecting to the moving IAB node.

5. The method of claim 1, further comprising:
changing, at the first device, from an F1-terminated (F1-T) CU to a non F1-T CU.

6. The method of claim 1, wherein the moving IAB node has a dual connection with a first parent IAB node which serves as a MN and a second parent IAB node, the second device is the second parent IAB node, and the first device is a donor centralized unit (CU) of the first parent IAB node and the second parent IAB node.

7. The method of claim 6, wherein transmitting the configuration information comprises:
transmitting, to the second device, a redundant path addition response comprising the configuration information, and
wherein the redundant path addition response further comprises:
a first identity of the moving IAB node.

8. The method of claim 6, further comprising:
in accordance with a determination that a MN/SN switch is to be performed, transmitting, to the moving IAB node, a UE context modification message to configure the RLC channel mapping rule.

9. The method of claim 6, further comprising:
in accordance with a determination that a MN/SN switch is to be performed, transmitting, to the moving IAB node, a backhaul adaption protocol (BAP) mapping configuration to configure the routing table.

10. The method of claim 6, further comprising:
transmitting, to the moving IAB node, a MN/SN switch message, wherein the MN/SN with message comprises:
a third indication regarding that the first parent IAB node is to change to the SN, and
a fourth indication regarding that the second parent IAB node is change to the MN.

11. A communication method, comprising:
receiving, at a second device which serves as a secondary node (SN) of a moving integrated access backhaul (IAB) node and from a first device, configuration information associated with the moving IAB node, and the configuration information comprises at least one of: a radio link control (RLC) channel of the moving IAB node, a RLC channel mapping rule of the moving IAB node, or a routing table of the moving IAB node.

12. The method of claim 11, wherein the moving IAB node has a dual connection with the first device and the second device, the first device is a first donor CU and serves as a master node (MN), and the second device is a second donor CU and serves as a secondary node (SN).

13. The method of claim 12, wherein receiving the configuration information comprises:
receiving, from the first device, a MN/SN switch request comprising the configuration information, and
wherein the MN/SN request further comprises at least one of:
an identity list of a set of terminal devices, the set of terminal devices connecting to the moving IAB node,
a first indication regarding that the first device is to change to the SN,
a second indication regarding that the second device is change to the MN, or
a radio resource control (RRC) container of the first device.

14. The method of claim 12, further comprising:
transmitting, to the first device, a MN/SN switch response, wherein the MN/SN switch response comprises at least one of:
at least one established RLC channel of the moving IAB node,
the RLC channel mapping rule of the second device,
a routing table of the second device, or
an identity list of a set of terminal devices, the set of terminal devices connecting to the moving IAB node.

15. The method of claim 11, wherein the moving IAB node has a dual connection with a first parent IAB node which serves as a MN and a second parent IAB node, the second device is the second parent IAB node, and the first device is a donor centralized unit (CU) of the first parent IAB node and the second parent IAB node.

16. The method of claim 15, wherein receiving the configuration information comprises:
receiving, from the first device, a redundant path addition response comprising the configuration information, and
wherein the redundant path addition response further comprises:
a first identity of the moving IAB node.

17-25. (canceled)

26. A first device comprising:
a processor; and
a memory coupled to the processor and storing instructions thereon, the instructions, when executed by the processor, causing the first device to: transmit, to a second device which serves as a secondary node (SN) of a moving integrated access backhaul (IAB) node, configuration information associated with the moving IAB node, and the configuration information comprises at least one of: a radio link control (RLC) channel of the moving IAB node, a RLC channel mapping rule of the moving IAB node, or a routing table of the moving IAB node.

27-30. (canceled)

31. The first device of claim 26, wherein the moving IAB node has a dual connection with the first device and the second device, the first device is a first donor centralized unit (CU) and serves as a master node (MN), and the second device is a second donor CU.

32. The first device of claim 31, wherein the first device is caused to transmit the configuration information by:
transmitting, to the second device, a MN/SN switch request comprising the configuration information, and
wherein the MN/SN request further comprises at least one of:
an identity list of a set of terminal devices, the set of terminal devices connecting to the moving IAB node,
a first indication regarding that the first device is to change to the SN,
a second indication regarding that the second device is to change to the MN, or
a radio resource control (RRC) container of the first device.

33. The first device of claim 31, wherein the first device is further caused to:
receive, from the second device, a MN/SN switch response, wherein the MN/SN switch response comprises at least one of:
at least one established RLC channel of the moving IAB node,
a RLC channel mapping rule of the second device,
a routing table of the second device, or
an identity list of a set of terminal devices, the set of terminal devices connecting to the moving IAB node.
